(19) United States
(12) Patent Application Publication
(10) Pub. No.: US 2016/0020982 A1
(43) Pub. Date: Jan. 21, 2016

(54) METHOD, DEVICE AND SYSTEM FOR ONLINE PROCESSING OF DATA

(71) Applicant: Huawei Technologies Co., Ltd., Shenzhen (CN)

(72) Inventors: Fei Chen, Hangzhou (CN); Heng Qiu, Shenzhen (CN); Puneet Gupta, Solitaire (IN)

(21) Appl. No.: 14/868,000

(22) Filed: Sep. 28, 2015

Related U.S. Application Data
(63) Continuation of application No. PCT/CN2013/084374, filed on Sep. 27, 2013.

(30) Foreign Application Priority Data
Apr. 1, 2013 (CN) 201310111060.6

(51) Int. Cl. H04L 12/26

(52) U.S. Cl. CPC H04L 43/0876

(57) ABSTRACT

A method, a device and a system for online data processing are provided. A central OLAP server sends a data request message to one or more sub OLAP servers. The central OLAP server receives user service data from the one or more sub OLAP servers. The user service data received from each OLAP server includes service volumes of one or more roaming users and service volumes of one or more non-roaming users that meet a first condition, and the service volume information of a user includes a user identifier and a service volume of the user. The central OLAP server then sums up a total service volume for each user based on the service volume information of the user reported by the sub OLAP servers, and obtains total service volume information of each of selected users whose total service volumes meet a second condition. The total service volume information of a user includes a user identifier and a total service volume of the user. Thus the efficiency of online data processing can be improved.

### CROSS-REFERENCE TO RELATED APPLICATIONS

This application is a continuation of International Application No. PCT/CN2013/084374, filed on Sep. 27, 2013, which claims priority to Chinese Patent Application No. 201310111060.6, filed on Apr. 1, 2013, both of which are hereby incorporated by reference in their entireties.

### TECHNICAL FIELD

The present application relates to data processing technologies, and in particular, to online data processing.

### BACKGROUND

With rapid development of network technologies and increasing popularity of networks, an operator's sub-networks (“subnets” for short) are distributed in an increasingly larger area. For example, subnets of one operator may be distributed in different geographic areas of a country. Generally, an online analytical processing (OLAP) server is equipped in each subnet of the operator, in order to obtain a service volume of the subnet. Such an OLAP server is referred to as a “sub OLAP server” hereinafter.

In the existing technology, for generating a central report based on service volumes of the subnets, a sub OLAP server in each subnet generally obtains a service volume of each user, and then service volume data of all users stored in the sub OLAP server is exported manually as a comma separated value (CSV) file. CSV files of sub OLAP servers are then imported manually into a separate database, and service volume data of all users in the database is aggregated to generate the central report.

However, generating the central report by aggregating the service volume data of all the users in the separate database involves a large amount of data processing, and has a low efficiency.

### SUMMARY

Embodiments of the present application provide a method, a device and a system for online data processing, so as to improve the efficiency of online data processing.

A central OLAP server sends a data request message to one or more sub OLAP servers. The central OLAP server receives user service data from one or more sub OLAP servers. The user service data received from each sub OLAP server includes service volume information of roaming users and service volume information of one or more non-roaming users that meet a first condition. In other words, the sub OLAP server screens the non-roaming users, and sends to the central OLAP server service volumes of only a part of the non-roaming users. The central OLAP server then sums up a total service volume for each user based on the service volume information of the user reported by the sub OLAP servers, and obtains total service volume information of each of selected users whose total service volumes meet a second condition. The total service volume information of a user includes a user identifier and a total service volume of the user.

In this way, the central OLAP server only needs to sum up the service volumes of the roaming users and the non-roaming users that meet the first condition, as reported by each sub OLAP server. That is, each sub OLAP server first collects statistics preliminarily, and then the central OLAP server further collects statistics based on preliminary statistical results of the sub OLAP servers, thereby reducing the amount of data processed by the central OLAP server, and improving the efficiency of online data processing.

### BRIEF DESCRIPTION OF THE DRAWINGS

To describe the technical solutions of the present application more clearly, various accompanying drawings are used. The following is a brief description of the accompanying drawings.

FIG. 1 is a flowchart a method for online data processing according to embodiments of the present application;

FIG. 2 is a flowchart of a method for online data processing according to embodiments of the present application;

FIG. 3 is a flowchart of a method for online data processing according to embodiments of the present application;

FIG. 4 is a flowchart of a method for online data processing according to embodiments of the present application;

FIG. 5 is a simplified functional block diagram of a central OLAP server according to embodiments of the present application;

FIG. 6 is a simplified structural diagram of a central OLAP server according to embodiments of the present application;

FIG. 7 is a simplified functional block diagram of a sub OLAP server according to embodiments of the present application;

FIG. 8 is a simplified structural diagram of a sub OLAP server according to embodiments of the present application;

FIG. 9 is a simplified block diagram of a system for online data processing according to embodiments of the present application; and

FIG. 10 is an application example according to embodiments of the present application.

### DETAILED DESCRIPTION

To make the objectives, technical solutions, and advantages of the embodiments of the present application clearer, the following clearly describes the technical solutions in the embodiments of the present application with reference to the accompanying drawings. Apparently, the embodiments to be described are a part rather than all of the embodiments of the present application. All other embodiments obtained by persons of ordinary skill in the art based on the following disclosure without creative efforts shall fall within the protection scope of the present application.

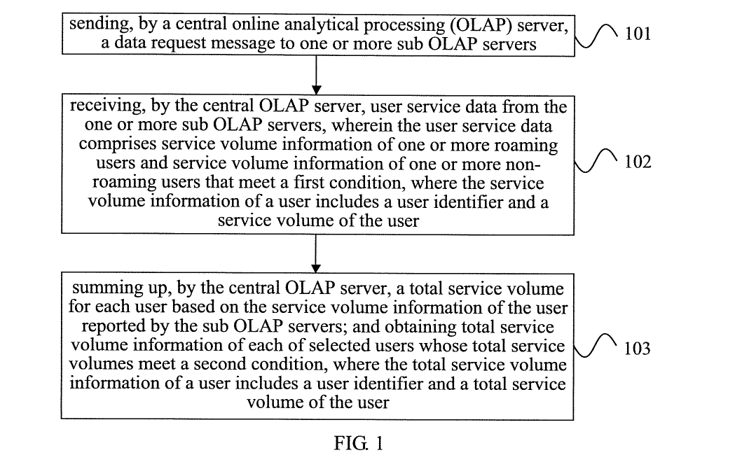

FIG. 1 is a flowchart of a method for online data processing according to embodiments of the present application. The method is performed by a central online analytical processing (OLAP) server, which comprises appropriate hardware and software to realize relevant functions, and which is in communication with one or more sub OLAP servers. As shown in FIG. 1, the method for online data processing includes the following steps.

Step 101: the central OLAP server sends a data request message to one or more sub OLAP servers.

Step 102: the central OLAP server receives user service data from the one or more sub OLAP servers. The user service data from each sub OLAP server includes service volume information of one or more roaming users and service volume information of one or more non-roaming users that meet a first condition, and the service volume information of a user as reported by each sub OLAP server includes a user identifier and a service volume of the user.

Step 103: the central OLAP server sums up a total service volume for each user based on the service volume information of the user reported by the sub OLAP servers, and obtains total service volume information of each of selected users whose total service volumes meet a second condition. The total service volume information of a user includes a user identifier and a total service volume of the user.

In further details, when a decision maker at an operator of a network needs to know an actual operating situation of the network and to make a related decision according to the operating situation, a query request may be sent to the central OLAP server of the network. The query request may indicate an item, the statistics of which need to be collected by the central OLAP server, and one or more statistical parameters for collecting the statistics of the item. The one or more statistical parameters may include any one or any combination of: a service type, a time segment, and a first condition (which is described below). The one or more statistical parameters may be carried in the query request, or may be preset as default parameters. Alternatively, the central OLAP server may determine all the statistical parameters according to a mapping relationship between a part of the statistical parameters that are carried in the query request and other statistical parameters that are preset. For example, a query request indicates a service type as a statistical parameter for collecting the statistics of an item (such as a service volume), and corresponding to the service type is a time segment that is a preset statistical parameter for collecting the statistics of the item. Accordingly, the central OLAP server may determine to collect the statistics of the item (such as a service volume) at the specified time segment and for the specified service type.

After receiving the query request, the central OLAP server sends a data request message to one or more sub OLAP servers, instructing the sub OLAP servers to perform a statistical analysis and report the user service data to the central OLAP server. The data request message may carry one or more data reporting parameters, or may not carry any data reporting parameter at all. The data reporting parameters may be the same or different from the statistical parameters indicated in the query request. It is to be understood that the process of collecting statistics may include activities such as collection, collation, computation and analysis of related data.

In the following, it is assumed that the statistical parameters are the same as the data reporting parameters. The sub OLAP server may collect statistical data of an item according to the data reporting parameters. In a specific implementation process, when the data request message does not include data reporting parameters, the sub OLAP server first obtains data reporting parameters associated with the data request message according to a predetermined mapping relationship between the data request message and the data reporting parameters, that is, after receiving the data request message, the sub OLAP server obtains the data reporting parameters according to the mapping relationship. Then the sub OLAP server may collect statistical data of an item according to the data reporting parameters.

In another implementation process, when the data request message carries data reporting parameters, the carried data reporting parameters are extracted from the data request message. Then, the sub OLAP server may collect statistical data of an item according to the data reporting parameters.

In another implementation process, when the data request message carries a part of data reporting parameters, the sub OLAP server determines all data reporting parameters which includes the part of data reporting parameters and the another part of data reporting parameters according to a predetermined mapping relationship between the part of data reporting parameters carried in the data request message and another part of data reporting parameters.

As a specific embodiment, the item of which the statistics needs to be collected is a service volume. In the data request message, the data reporting parameters include any one or a combination of the following: a service type, a time segment, and a first condition. The service type parameter may include a data service, a video service, a voice service, and the like. The time segment parameter may include a start time and an end time, for example, from 7 p.m. to 9 p.m. on Dec. 18, 2012. The specific time segment parameter is not particularly limited herein. The first condition may be that only when a service volume of a non-roaming user meets that condition, the service volume data of this user is returned by the sub OLAP server to the central OLAP server, whereas service volumes of all roaming users are returned by the sub OLAP server to the central OLAP server. Because the data reporting parameters are carried or indicated in the data request message sent to all the sub OLAP servers, the central OLAP server can manage data statistics in a unified manner, and the sub OLAP servers do not need to store the data reporting parameter, thereby reducing the amount of data stored in each sub OLAP server.

In some specific application scenarios, sub OLAP servers may be distributed in subnets that are deployed by the operator in different geographic areas, the subnets may be in unit of cities, and a user may be a user using a mobile terminal. After collecting statistics on service volume information of a user according to the data request message, each sub OLAP server sends user service data to the central OLAP server. The central OLAP server receives the user service data sent from the one or more sub OLAP server. The user service data includes user identifiers and service volumes that are corresponding to the user identifiers. Herein, the user identifier may be various identifiers of the mobile terminal, for example, an international mobile subscriber identity or a mobile phone number, and the service volume is a service volume corresponding to the user identifier.

For example, a sub OLAP server is located in Guangzhou. The service type is a traffic service, the time segment is the third quarter, and the first condition is a condition with traffic greater than a first preset threshold. The user service data gathered by the sub OLAP server includes: traffic information of a roaming user, for example, traffic infatuation of traffic generated when a user whose home location is Shenzhen roams to Guangzhou in the third quarter and uses the traffic service in Guangzhou as a roaming user. Persons skilled in the art may understand that in a specific implementation process, traffic information of traffic generated by each user who roams to Guangzhou and uses the traffic service in Guangzhou is traffic information of a roaming user.

The user service data further includes the service volume information of the non-roaming users that meets the first condition, that is, traffic information of traffic generated by a user whose home location is Guangzhou and who uses the traffic service locally in Guangzhou. However, because there are a relatively large number of users whose home locations are Guangzhou, and some users may use the traffic service in the third quarter at relatively low frequency or little traffic is generated. A statistical result obtained by collecting statistics on these users does not contribute much to helping the operator know an actual operating situation of a network. In addition, a large amount of data also increases the processing burden of the central OLAP server. Therefore, the sub OLAP server screens non-roaming users to obtain non-roaming users that meet the first condition, for example, when traffic of a non-roaming user is greater than the first preset threshold, the non-roaming user is a non-roaming user that meets the first condition.

In addition to the first condition described above, the first condition may also be a condition that a service volume ranks before a first preset ranking in service volumes of all non-roaming users. For example, when the first preset ranking is 1000, non-roaming users whose total traffic in the third quarter ranks top 1000 are non-roaming users that meet the first condition.

Persons skilled in the art may understand that service volume statistical information received by the central OLAP server is service volume statistical information sent by multiple sub OLAP servers, and the service volume statistical info illation sent by each sub OLAP server is similar to that in the foregoing embodiment in which the sub OLAP server is located in Guangzhou, and examples are not repeatedly described herein in this embodiment.

After receiving the user service data sent by the one or more sub OLAP servers, the central OLAP server sums up a total service volume for each user based on the service volume information of the user reported by the sub OLAP servers, and obtains total service volume information of each of selected users whose total service volumes meet a second condition. The total service volume info nation of a user includes a user identifier and a total service volume of the user.

Persons skilled in the art may understand that within the time segment, when a user not only uses a service at the home location but also uses the service in multiple other geographic areas to which the user roams, the central OLAP server receives service volume information that is of the user as a roaming user and is separately sent by multiple sub OLAP servers corresponding to the multiple geographic areas to which the user roams. Meanwhile, the central OLAP server also receives service volume information that is of the user as a non-roaming user and is sent by a sub OLAP server corresponding to the home location of the user. Therefore, if it is required to obtain a corresponding time segment of the user, that is, information about a total service volume that occurs within a statistical time segment, statistics may be collected on a total service volume of the user as a roaming user and a non-roaming user based on the user identifier of the user, that is, all service volumes corresponding to a same user identifier may be summed up, so as to obtain a total service volume of the user.

Within the statistical time segment, for a user who does not roam to another geographic area to use a service, when service volumes are summed up based on the user identifier of the user, a total service volume of the user is a service volume of the user as a non-roaming user.

After a total service volume of each user is obtained, the total service volume information of each user whose total service volumes meets the second condition is determined according to a total service volume of each user. Herein, the second condition may be a preset second condition, or may be a second condition carried in the query request when the operator triggers the query request. A specific manner of obtaining the second condition is not particularly limited herein in this embodiment.

In a possible implementation manner, the second condition is a condition that a total service volume is greater than a second preset threshold, or a condition that a total service volume ranks before a second preset ranking in total service volumes of all users. Specifically, the central OLAP server further screens the users. Assuming that the service type is a traffic service parameter, when a total traffic of a user is greater than the second preset threshold, or a total traffic of the user ranks before the second preset ranking, the user is a user that meets the second condition, and total service volume information of the user that meets the second condition is stored and recorded, where the total service volume information of a user includes a user identifier and a total service volume of the user.

In the method for online data processing provided in the embodiment of the present application, a central OLAP server sends a data request message to one or more sub OLAP servers, and the central OLAP server receives user service data sent by the one or more sub OLAP servers, where the user service data includes service volume information of one or more roaming users and service volume information of one or more non-roaming users who meet a first condition, that is, the sub OLAP server screens the non-roaming users, and the central OLAP server only receives service volume information of a part of the non-roaming users; and the central OLAP server sums up a total service volume for each user based on the service volume information of the user reported by the sub OLAP servers, and obtain total service volume information of each of selected users whose total service volumes meet a second condition, where the central OLAP server only needs to sum up service volumes of the roaming users and service volumes of the non-roaming users that meet the first condition, where the service volumes are reported by the sub OLAP servers, that is, the sub OLAP servers first collects statistics preliminarily, and then the central OLAP server further collects statistics based on a preliminary statistical result of the sub OLAP servers, thereby reducing the amount of data processed by the central OLAP server, and improving the efficiency of data processing.

Further, after the central OLAP server sums up a total service volume for each user based on the user identifiers and the corresponding service volumes and obtains total service volume information of each of selected users whose total service volumes meets a second condition, the central OLAP server generates a multi-dimensional service volume graph according to the total service volume information of each of one or more users whose total service volumes meets the second condition.

In a specific implementation process, the central OLAP server may generate the multi-dimensional service volume graph according to the total service volume information of each of one or more users whose total service volumes meets the second condition by following a multi-aspect thinking pattern of the decision maker, where a dimension refers to an aspect of analysis. For example, the time segment is a dimension, and the service type parameter and the user identifier are also dimensions.

In the method for online data processing provided in this embodiment, the decision maker can rapidly obtain data from various aspects of analysis according to the multi-dimensional service volume graph, and can also switch between the aspects dynamically or perform comprehensive analysis from multiple aspects, thereby providing extremely high flexibility in analysis.

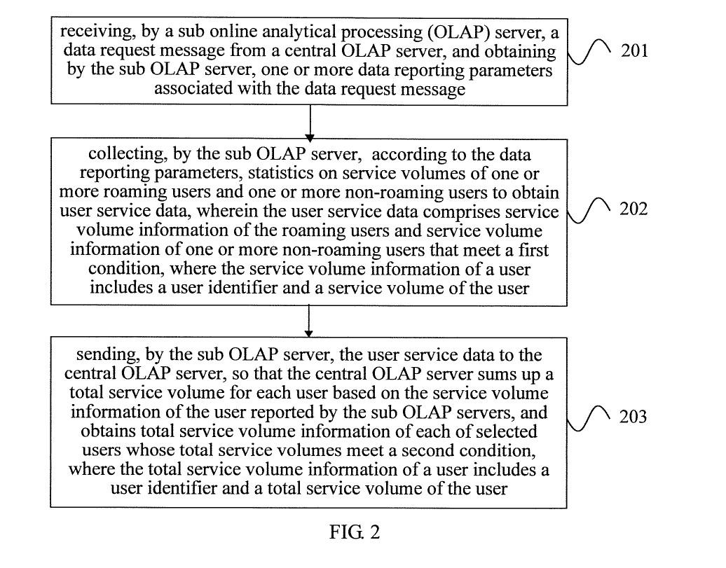

FIG. 2 is a flowchart of a method for online data processing according to embodiments of the present application. The method, which is performed by a sub OLAP server, includes the following steps.

Step 201: the sub OLAP server receives a data request message sent from a central OLAP server, and obtains a data reporting parameter associated with the data request message.

Step 202: the sub OLAP server collects, according to the data reporting parameter, statistics on service volumes of one or more roaming users and one or more non-roaming users to obtain user service data, where the user service data includes service volume information of the roaming users and service volume information of one or more non-roaming users that meet a first condition, and the service volume information of a user includes a user identifier and a service volume of the user.

Step 203: the sub OLAP server sends the user service data to the central OLAP server, so that the central OLAP server sums up a total service volume for each user based on the service volume information of the user reported by the sub OLAP servers and obtains total service volume information of each of one or more users whose total service volumes meets a second condition, where the total service volume information of a user includes a user identifier and a total service volume of the user.

The sub OLAP server receives a data request message sent by the central OLAP server, and collects statistics on data. Before collecting statistics on data, the sub OLAP server needs to obtain a data reporting parameter associated with the data request message. Manners of obtaining the data reporting parameter associated with the data request message include the following possible implementation manners: One possible implementation manner is to obtain, according to a predetermined mapping relationship between the data request message and the data reporting parameter, the data reporting parameter associated with the data request message, that is, after receiving the data request message, the sub OLAP server obtains the data reporting parameter according to the mapping relationship. Another possible implementation manner is: if the data request message carries a data reporting parameter, the sub OLAP server extracts the carried data reporting parameter from the data request message.

The sub OLAP server collects statistics on service volumes of one or more roaming users and one or more non-roaming users according to the data reporting parameter to obtain service volume information of the roaming users and service volume information of one or more non-roaming users who meet the first condition.

Herein, the data reporting parameter includes any one or a combination of the following: a service type, a time segment, and the first condition.

The sub OLAP server may collect statistics according to specific content of the data reporting parameter. For example, if the data reporting parameter includes the service type, the sub OLAP server collects, according to the data reporting parameter, statistics on service volumes that are corresponding to the service type and that are of the roaming users and the non-roaming users to obtain the user service data

If the data reporting parameter includes the time segment, the sub OLAP server collects, according to the data reporting parameter, statistics on service volumes that are corresponding to the time segment and that are of the roaming users and the non-roaming users to obtain the user service data.

Persons skilled in the art may understand that in an actual operation process, the time segment and the service type parameter may further be combined to collect statistics on service volumes of a specific service type of the roaming users and the non-roaming users within a statistical time segment.

To improve the processing efficiency of the central OLAP server, the sub OLAP server must also determine the one or more non-roaming users that meet the first condition. In a feasible embodiment, the first condition is a condition that a service volume is greater than a first preset threshold, or a condition that a service volume ranks before a first preset ranking in service volumes of all non-roaming users.

In a feasible embodiment, the second condition is a condition that a total service volume is greater than a second preset threshold, or a condition that a total service volume ranks before a second preset ranking in total service volumes of all users.

In the method for online data processing provided in the embodiment of the present application, a sub OLAP server receives a data request message sent by a central OLAP server; collects statistics on service volumes of one or more roaming users and one or more non-roaming users to obtain user service data, where the user service data includes service volume information of the roaming users and service volume information of one or more non-roaming users that meet a first condition, and the service volume information includes a user identifier and a service volume; and sends the user service data to the central OLAP server. In other words, the sub OLAP server screens the non-roaming users and sends service volume information of only a part of the non-roaming users to the central OLAP server, so that the central OLAP server only needs to sum up service volumes that are of the roaming users and are reported by the sub OLAP server, and service volumes that are of the non-roaming users that meet the first condition and are reported by the sub OLAP server, that the sub OLAP server first collects statistics preliminarily, and then the central OLAP server further collects statistics based on a preliminary statistical result of the sub OLAP server, thereby reducing the amount of data processed by the central OLAP server and improving the efficiency of data processing.

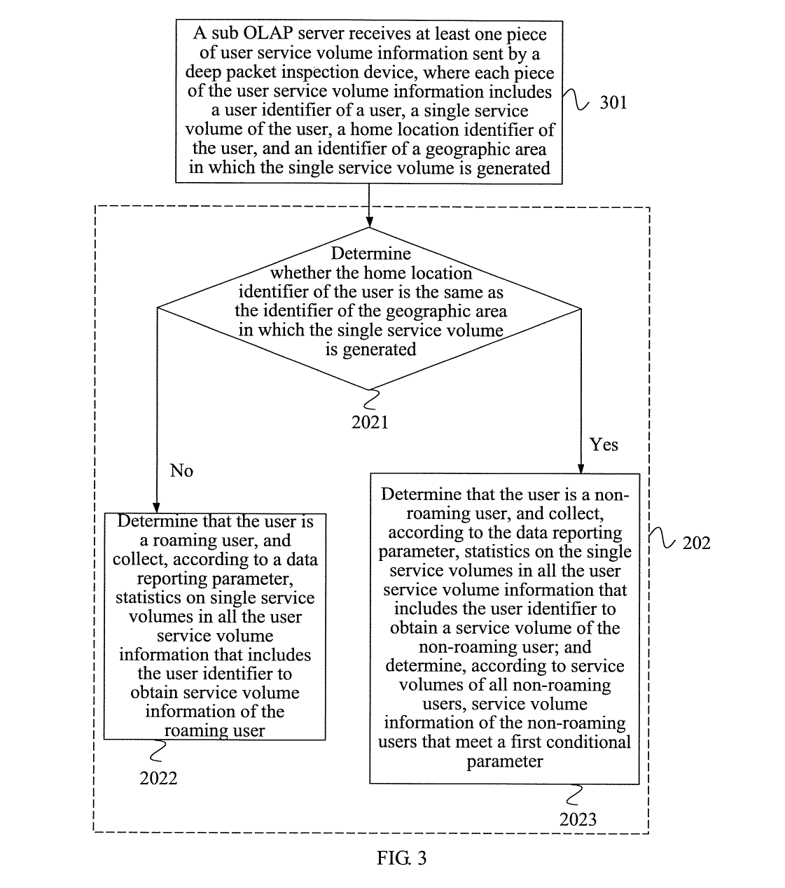

FIG. 3 is a flowchart describing in detail step 202 in the embodiment of FIG. 2.

Before step 202, step 301 is further included. In step 301, the sub OLAP server receives at least one piece of user service volume information sent by a deep packet inspection (DPI) device, where each piece of the user service volume information includes a user identifier of a user, a single service volume of the user, a home location identifier of the user, and an identifier of a geographic area in which the single service volume is generated.

The deep packet inspection device is capable of perceiving a network application, and capable of detecting traffic based on an application layer. In a specific implementation process, on one hand, the DPI device may be a server that has a DPI function and connected to a gateway device disposed in each geographic area; on the other hand, because access of mobile terminals of users in each geographic area are finally converged to the gateway device, a DPI module may be disposed in the gateway device, so that the gateway has a DPI capability and functions as a DPI device. In addition, each sub OLAP server has a gateway that is connected to the sub OLAP server. When the DPI device learns that a user uses a service within an area corresponding to the gateway, the DPI device sends at least one piece of user service volume information to the sub OLAP server, where the user service volume information includes a user identifier of the user, a single service volume, a home location identifier, and an identifier of a geographic area in which the single service volume is generated.

Herein, the user identifier of the user may be a mobile phone number of a mobile terminal of the user; the identifier of the geographic area in which the single service volume is generated may be an identifier of a place in which the single service volume is generated; the single service volume of the user may be a service volume generated when the user uses a service once, for example, traffic generated when the user uses a traffic service once, or a call duration generated when the user uses a call service once. A specific manner of the single service volume is not particularly limited herein in this embodiment. Particularly, the home location identifier and the identifier of the geographic area in which the single service volume is generated may be a device number of a corresponding DPI device. For example, as shown in Table 1, sub OLAP servers located in different geographic areas all have corresponding DPI devices, where a device number of a DPI device corresponding to a sub OLAP server located in Shenzhen is 1001, a device number of a DPI device corresponding to a sub OLAP server located in Guangzhou is 1002, a device number of a DPI device corresponding to a sub OLAP server located in Zhuhai is 1003, and a device number of a DPI device corresponding to a sub OLAP server located in Dongguan is 1004. Mapping information in Table 1 may be used as metadata, which is maintained by each DPI device.

TABLE 1

| Device Number | Area Code | Area Name |
|---|---|---|
| 1001 | 755 | Shenzhen |
| 1002 | 20 | Guangzhou |
| 1003 | 756 | Zhuhai |
| 1004 | 769 | Dongguan |

For example, when a user whose home location is Shenzhen (the home location identifier is 1001) roams to Guangzhou, uses a service in Guangzhou and generates corresponding traffic (the identifier of the geographic area in which the single service volume is generated is 1002), a DPI device located in Guangzhou perceives this behavior of the user, and sends user service volume information to a sub OLAP server connected to the DPI device, where the information includes a mobile phone number of the user, the single service volume, the home location identifier 1001, and the identifier 1002 of the geographic area in which the single service volume is generated. Persons skilled in the art may understand that when the sub OLAP server receives the user service volume information sent by the DPI device, the sub OLAP server may receive the user service volume information piece by piece in real time, or may receive multiple pieces of the user service volume information simultaneously in batches. A specific implementation manner of receiving the user service volume information by the sub OLAP server is not repeatedly described herein in this embodiment.

In a feasible embodiment, after receiving the user service volume information sent by the DPI device, the sub OLAP server stores the user service volume information. In a specific implementation process, a new user information table may be created, where the user information table is used for storing the user service volume information, such as the identifier of the user, the home location identifier, the identifier of the geographic area in which the single service volume is generated, and the service volume. When the DPI device sends the user service volume information to the sub OLAP server, the sub OLAP server may add the user service volume information into the user information table. To differentiate user service volume information of a user and determine a time at which the service volume is generated, a field of a time point at which the single service volume is generated may further be added to the user information table, and be used to record the time at which the single service volume is generated.

Correspondingly, the step 202 specifically includes:

Step 2021: Determine whether the home location identifier of the user is the same as the identifier of the geographic area in which the single service volume is generated; if not, perform step 2022; and if yes, perform step 2023.

Step 2022: Determine that the user is a roaming user, and collect, according to the data reporting parameter, statistics on single service volumes in all the user service volume information that includes the user identifier to obtain service volume information of the roaming user.

Step 2023: Determine that the user is a non-roaming user, and collect, according to the data reporting parameter, statistics on single service volumes in all the user service volume information that includes the user identifier to obtain a service volume of the non-roaming user; and determine, according to service volumes of all non-roaming users, service volume information of one or more non-roaming users that meet a first condition.

In a specific implementation process, the sub OLAP server may obtain related information directly from the user information table. For example, in step 2021, the sub OLAP server may determine whether the user is a roaming user or a non-roaming user according to the home location identifier and the identifier of the geographic area in which the single service volume is generated in the user information table. Table 2 below only lists a part of fields in the user information table: a user identifier, a home location identifier, and an identifier of a geographic area in which a single service volume is generated.

TABLE 2

| User | Home location | Identifier of a geographic area in which |
|---|---|---|
| identifier | identifier | a single service volume is generated |
| 13512345678 | 1001 | 1002 |
| 13222345678 | 1002 | 1002 |

The sub OLAP server determines whether the home location identifier is the same as the identifier of the geographic area in which the single service volume is generated, that is, the sub OLAP server determines, when a same user in Table 2 generates a single service volume, whether the home location identifier of the user is the same as the identifier of the geographic area in which the single service volume is generated. For example, for user 13512345678, a home location identifier 1001 of the user is different from an identifier 1002 of a geographic area in which a single service volume is generated, and accordingly it is determined that the user is a roaming user, and step 2022 is performed. For user 13222345678, a home location identifier 1002 of the user is the same as an identifier 1002 of a geographic area in which a single service volume is generated, and accordingly it is determined that the user is a non-roaming user, and step 2023 is performed.

In a feasible embodiment, after it is determined whether the user is a roaming user or a non-roaming user, a roaming information table and a non-roaming information table may be created according to the user information table. Herein, the roaming information table may include only a user identifier of a roaming user, a single service volume of the roaming user, and a time at which the single service volume is generated; and correspondingly, the non-roaming information table may also include only a user identifier of a non-roaming user, a single service volume of the non-roaming user, and a time at which the single service volume is generated. Persons skilled in the art may understand that there are various manners of creating a table in this embodiment, and a specific manner of creating a table is not particularly limited herein in this embodiment.

In step 2022, when it is determined that a current user is a roaming user, statistics are collected, according to the data reporting parameter, on single service volumes in all user service volume information that includes the user identifier to obtain a service volume of the roaming user. Specifically, statistics may be collected according to parameters in the data reporting parameter. For example, when the time segment indicates that the statistical time segment is the second week of May, and the service type is a traffic service parameter, all single service volumes belonging to the traffic service of the user that are generated within the time segment are accumulated.

In step 2023, when it is determined that the current user is a non-roaming user, statistics are collected, according to the data reporting parameter, on single service volumes in all user service volume information that includes the user identifier to obtain a service volume of the non-roaming user, and user identifiers and service volumes of the one or more non-roaming users that meet the first condition are determined according to service volumes of all non-roaming users. Specifically, statistics may be collected according to parameters in the data reporting parameter. For example, statistics are collected on service volumes belonging to the traffic service of all non-roaming users within a statistical time segment of 7 p.m. to 8 p.m. and a user identifier and a service volume of a non-roaming user that meets the first condition are determined according to the single service volumes of the traffic service of all the non-roaming users. The first condition may be a condition that the service volume is greater than a first preset threshold. By determining service volume information based on a roaming user and determining service volume information based on a non-roaming user that meets a first condition, the method for online data processing of this embodiment is highly targeted and avoids a meaningless waste of system resources, thereby greatly improving the performance of the method for online data processing.

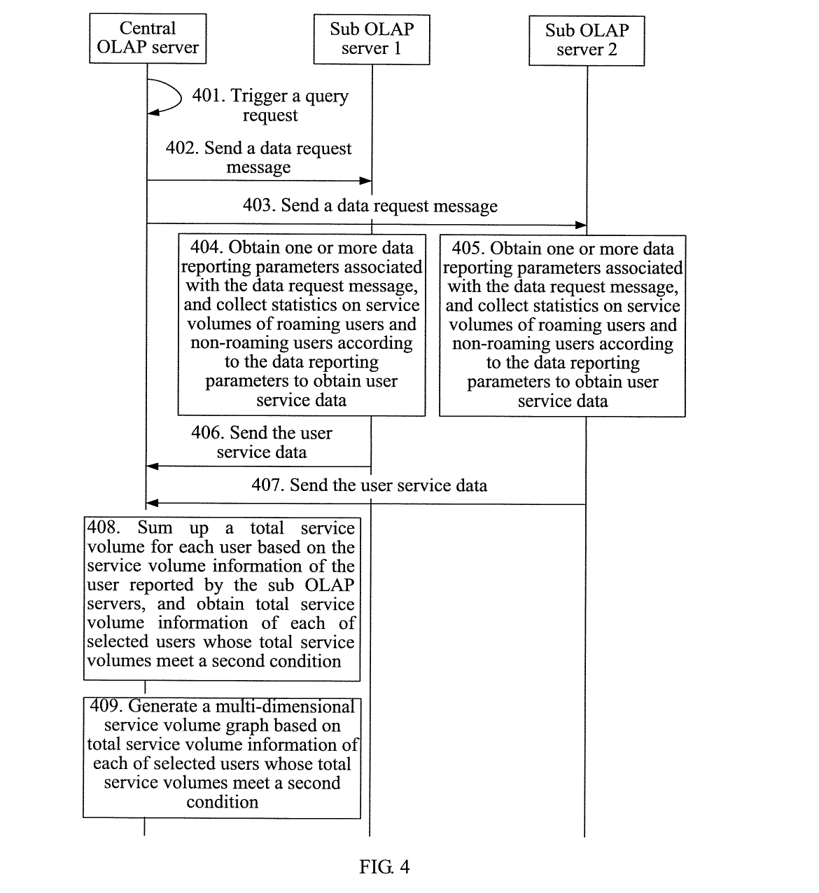

FIG. 4 is a flowchart of Embodiment 4 of an online data processing method of the present invention. As shown in FIG. 4, two sub OLAP servers are used as an example, that is, when a decision maker of an operator triggers a query request, the online data processing method of this embodiment includes the following steps:

Step 401. A decision maker triggers a query request to a central OLAP server.

Step 402. The central OLAP server sends a data request message to sub OLAP server 1.

Step 403. The central OLAP server sends a data request message to sub OLAP server 2.

Persons skilled in the art may understand that there is no strict timing relationship between step 402 and step 403, and the two may be performed simultaneously.

Step 404. Sub OLAP server 1 obtains a data reporting parameter associated with the data request message, and collects statistics on service volumes of one or more roaming users and one or more non-roaming users according to the data reporting parameter to obtain user service data. The user service data comprises service volume information of the roaming users and service volume information of one or more non-roaming users that meet a first condition.

Step 405. Sub OLAP server 2 obtains a data reporting parameter associated with the data request message, and collects statistics on service volumes of one or more roaming users and one or more non-roaming users according to the data reporting parameter to obtain user service data.

Persons skilled in the art may understand that there is no strict timing relationship between step 404 and step 405, and the two may be performed simultaneously. For a specific embodiment, reference may be made to the embodiments shown in FIG. 2 and FIG. 3, which are not repeatedly described herein in this embodiment.

Step 406. Sub OLAP server 1 sends the user service data to the central OLAP server.

Step 407. Sub OLAP server 2 sends the user service data to the central OLAP server.

Persons skilled in the art may understand that there is no strict timing relationship between step 406 and step 407, and the two may be performed simultaneously.

Step 408. The central OLAP server sums up a total service volume for each user based on the service volume information of the user reported by the sub OLAP servers, and obtains total service volume information of each of selected users whose total service volumes meet a second condition. The total service volume information of a user includes a user identifier and a total service volume of the user.

Step 409. The central OLAP server generates a multi-dimensional service volume graph according to the total service volume information of each of one or more users whose total service volumes meet a second condition.

For a specific embodiment of step 408 and step 409, reference may be made to the embodiment shown in FIG. 1, and details are not repeatedly described herein in this embodiment.

This embodiment only uses two sub OLAP servers as an example, and in a specific application process, the number of sub OLAP servers may be greater. For an online data processing method that is performed by each sub OLAP server, reference may be made to the embodiments shown in FIG. 2 and FIG. 3. For an online data processing method that is performed by the central OLAP server, reference may be made to the embodiment shown in FIG. 1.

The embodiment shown in FIG. 4 is used. In a specific example, there are four sub OLAP servers in an operator's network, each sub OLAP server covering an area. Each sub OLAP server serves 1 million users, so there are 4 million users in total. It is assumed that 15% of all the users may roam to other three areas, 20% of all the users may roam to other two areas, 25% of all the users may roam to another area, and remaining 40% of all the users do not have a roaming behavior. A service type on which statistics need to be collected is traffic service, and a statistical time segment is Jan. 1, 2012 to Jan. 31, 2012. According to the method for online data processing of this embodiment, there are about 237,000 pieces of user service volume information on which statistics have finally been collected by the central OLAP server, and a time for generating a multi-dimensional service volume graph by the central OLAP server is estimated to be 121 seconds. On the other hand, according to a generating method in the prior art, in the same scenario and under the same condition, there are about 400,000 records on which statistics have finally been collected by the central OLAP server, and a time for generating a multi-dimensional service volume graph finally is estimated to be 517 seconds. Compared with the prior art, the performance of the method for online data processing provided in this embodiment is improved by 76.6%.

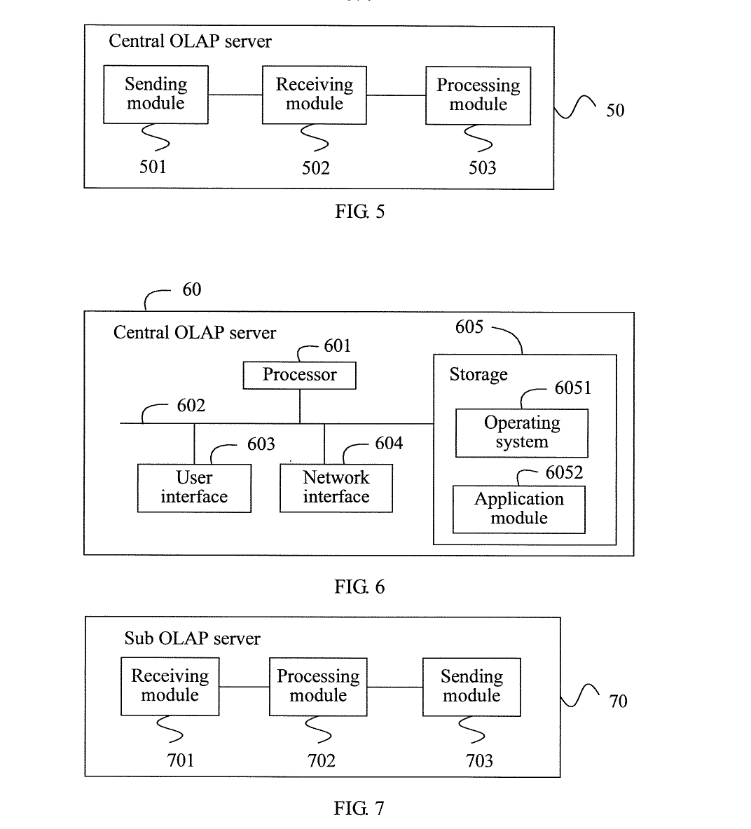

FIG. 5 is a simplified functional block diagram of a central OLAP server according to embodiments of the present application. As shown in FIG. 5, the central OLAP server 50, in functional blocks, includes a sending module 501, a receiving module 502, and a processing module 503.

Herein, the sending module 501 is configured to send a data request message to one or more sub online analytical processing OLAP server.

The receiving module 502 is configured to receive user service data sent by the one or more sub OLAP servers, where the user service data includes service volume information of one or more roaming users and service volume information of one or more non-roaming users that meet a first condition, and service volume information of a user includes a user identifier and a service volume of the user.

The processing module 503 is configured to sum up a total service volume for each user based on the service volume information of the user reported by the sub OLAP servers, and obtains total service volume information of each of selected users whose total service volumes meet a second condition. The total service volume information of a user includes a user identifier and a total service volume of the user.

The central OLAP server may specifically be configured to implement the technical solution of the first embodiment as shown in FIG. 1 and described above. The implementation principles and technical effects are similar to those of the embodiment, and details are not repeatedly described herein.

Further, the processing module 503 is specifically configured to:

sum up a total service volume for each user based on the user identifier of the user and the service volume of the user as a roaming user and a non-roaming user; and

determine, based on the total service volume for each user, the total service volume information of each of one or more users whose total service volumes meets the second condition.

Further, the sending module 501 is specifically configured to send a data request message that carries a data reporting parameter to the one or more sub OLAP servers, where the data reporting parameter includes any one or a combination of the following: a service type, a time segment, and the first condition.

Further, the first condition is a condition that a service volume is greater than a first preset threshold, or a condition that a service volume ranks before a first preset ranking in service volumes of all non-roaming users; and

the second condition is a condition that a total service volume is greater than a second preset threshold, or a condition that a total service volume ranks before a second preset ranking in total service volumes of all users.

Further, the processing module 503 is further configured to:

generate a multi-dimensional service volume graph according to the total service volume information of each of one or more users whose total service volumes meets the second condition.

Further, sub OLAP servers are deployed in different geographic areas.

FIG. 6 is a simplified block diagram of a central OLAP server of the present application. As shown in FIG. 6, the central OLAP server 60 includes: at least one processor 601 such as a CPU, at least one network interface 604 or another user interface 603, a storage 605, and at least one communications bus 602. The communications bus 602 is configured to implement connection and communication between the components. The user interface 603 optionally included by the central OLAP server 60 includes a display, a keyboard, or a pointing device (for example, a mouse, a trackball, a touch panel, or a touchscreen). The storage 605 may include a high speed RAM and may also include a non-volatile memory, for example, at least one disk storage. The storage 605 optionally may include at least one storage apparatus located away from the processor 601.

Specifically, the processor 601 is configured to send a data request message to one or more sub online analytical processing OLAP servers;

receive user service data sent by the one or more sub OLAP servers, where the user service data includes service volume information of one or more roaming users and service volume information of one or more non-roaming users that meet a first condition, and the service volume information of a user includes a user identifier and a service volume of the user; and

sum up a total service volume for each user based on the service volume information of the user reported by the sub OLAP servers, and obtains total service volume information of each of selected users whose total service volumes meet a second condition. The total service volume information of a user includes a user identifier and a total service volume of the user.

Further, service volume information of a user as reported by each sub OLAP server comprises a user identifier and a service volume of the user, and the processor is further configured to sum up a total service volume for each user based on the user identifier of the user and the service volume of the user as a roaming user and a non-roaming user, and determine, based on the total service volume for each user, the total service volume information of each of one or more users whose total service volumes meets the second condition.

Further, the data request message carries one or more data reporting parameters for collecting service volume information of each user according to the data reporting parameters. The one or more data reporting parameters comprise any one or any combination of:
a service type;
a time segment; and
the first condition.

Further, the first condition is a condition that a service volume is greater than a first preset threshold, or a condition that a service volume ranks before a first preset ranking in service volumes of all non-roaming users.

The second condition is a condition that a total service volume is greater than a second preset threshold, or a condition that a total service volume ranks before a second preset ranking in total service volumes of all users.

Further, the processor is further configured to:

generate a multi-dimensional service volume graph according to the total service volume information of each of one or more users whose total service volumes meets the second condition.

The implementation principles and technical effects of the central OLAP server are similar to those of the embodiment, and details are not repeatedly described herein.

FIG. 7 is a functional block diagram of a sub OLAP server. As shown in FIG. 7, the sub OLAP server 70, in functional blocks, includes a receiving module 701, a processing module 702, and a sending module 703.

The receiving module 701 is configured to receive a data request message sent by a central OLAP server, and obtain a data reporting parameter associated with the data request message.

The processing module 702 is configured to collect, according to the data reporting parameter, statistics on service volumes of one or more roaming users and one or more non-roaming users to obtain user service data, where the user service data includes service volume information of the roaming users and service volume information of one or more non-roaming users that meet a first condition, and the service volume information includes user identifiers and corresponding service volumes.

The sending module 703 is configured to send the user service data to the central OLAP server, so that the central OLAP server sums up a total service volume for each user based on the service volume information of the user reported by the sub OLAP servers, and obtains total service volume information of each of selected users whose total service volumes meet a second condition. The total service volume information of a user includes a user identifier and a total service volume of the user.

The receiving module 701 is further configured to receive at least one piece of user service volume information sent by a deep packet inspection device, where each piece of the user service volume information includes a user identifier of a user, a single service volume of the user, a home location identifier of the user, and an identifier of a geographic area in which the single service volume is generated.

The processing module 702 is specifically configured to:

if the home location identifier of the user is different from the identifier of the geographic area in which the single service volume is generated, determine that the user is a roaming user, and collect, according to the data reporting parameter, statistics on single service volumes in all the user service volume information that includes the user identifier to obtain service volume information of the roaming user; and

if the home location identifier of the user is the same as the identifier of the geographic area in which the single service volume is generated, determine that the user is a non-roaming user, and collect, according to the data reporting parameter, statistics on single service volumes in all the user service volume information that includes the user identifier to obtain a service volume of the non-roaming user; and determine, according to service volumes of all non-roaming users, service volume information of one or more non-roaming users that meet the first condition.

Further, the data reporting parameter includes any one or a combination of the following: a service type, a time segment, and the first condition.

The processing module 702 is specifically configured to: if the data reporting parameter includes the service type, collect statistics on service volumes that are corresponding to the service type and that are of the roaming users and the non-roaming users to obtain user service data, where the user service data includes service volume information of the roaming users and service volume information of one or more non-roaming users that meet the first condition, and the service volume information includes user identifiers and corresponding service volumes; or,

the processing module 702 is specifically configured to: if the data reporting parameter includes the time segment, collect statistics on service volumes that are corresponding to the time segment and that are of the roaming users and the non-roaming users, where the user service data includes service volume information of the roaming users and service volume information of one or more non-roaming users that meet the first condition, and the service volume information includes user identifiers and corresponding service volumes.

Further, the first condition is a condition that a service volume is greater than a first preset threshold, or a condition that a service volume ranks before a first preset ranking in service volumes of all non-roaming users; and

the second condition is a condition that a total service volume is greater than a second preset threshold, or a condition that a total service volume ranks before a second preset ranking in total service volumes of all users.

Further, the receiving module 701 is specifically configured to receive the data request message sent by the central online analytical processing OLAP server, and obtain, according to a predetermined mapping relationship between the data request message and the data reporting parameter, the data reporting parameter associated with the data request message; or,

the receiving module 701 is specifically configured to: receive the data request message sent by the central online analytical processing OLAP server, and if the data request message carries a data reporting parameter, extract the carried data reporting parameter from the data request message.

The sub online analytical processing server of this embodiment may be configured to implement the technical solution of the foregoing embodiment of the method for online data processing. The implementation principles and technical effects of the sub online analytical processing server are similar to those of the method embodiment, and details are not repeatedly described herein.

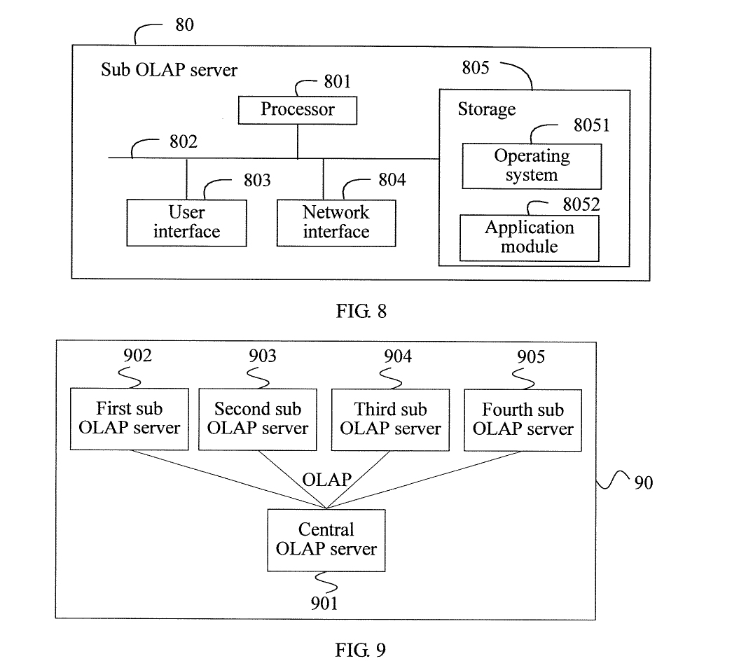

FIG. 8 is a simplified block diagram of a sub OLAP server of the present application. As shown in FIG. 8, the sub OLAP server 80 includes: at least one processor 801 such as a CPU, at least one network interface 804 or another user interface 803, a storage 805, and at least one communications bus 802. The communications bus 802 is configured to implement connection and communication between the components. The user interface 803 optionally included by the sub OLAP server 80 includes a display, a keyboard, or a pointing device (for example, a mouse, a trackball, a touch panel, or a touchscreen). The storage 805 may include a high speed RAM memory, and may also include a non-volatile memory, for example, at least one disk storage. The storage 805 optionally may include at least one storage apparatus located away from the processor 801.

In some implementation manners, the storage 805 stores the following elements, executable modules or data structures, or their subsets, or their extension sets:

an operating system 8051, including various system programs and configured to implement various fundamental services and process hardware-based tasks; and

an application module 8052, including various application programs and configured to implement various application services.

The application module 8052 includes, but is not limited to, the receiving module 701, the processing module 702, and the sending module 703.

For specific implementation of modules in the application module 8052, reference may be made to corresponding modules in the embodiment shown in FIG. 7, and details are not repeatedly described herein.

Specifically, the processor 801 is configured to receive a data request message sent by a central OLAP server, and obtain a data reporting parameter associated with the data request message;

collect, according to the data reporting parameter, statistics on service volumes of one or more roaming users and one or more non-roaming users to obtain user service data, where the user service data includes service volume information of the roaming users and service volume information of one or more non-roaming users that meet a first condition, and the service volume information of a user includes a user identifier and a service volume of the user; and

send the user service data to the central OLAP server, so that the central OLAP server sums up a total service volume for each user based on the service volume information of the user reported by the sub OLAP servers, and obtains total service volume information of each of selected users whose total service volumes meet a second condition. The total service volume information of a user includes a user identifier and a total service volume of the user.

Further, the processor 801 is further configured to: receive at least one piece of user service volume information sent by a deep packet inspection device, where each piece of the user service volume information includes a user identifier of a user, a single service volume of the user, a home location identifier of the user, and an identifier of a geographic area in which the single service volume is generated; and

the collecting, according to the data reporting parameter, statistics on service volumes of one or more roaming users and one or more non-roaming users to obtain user service data includes:

if the home location identifier of the user is different from the identifier of the geographic area in which the single service volume is generated, determining that the user is a roaming user, and collecting, according to the data reporting parameter, statistics on single service volumes in all the user service volume information that includes the user identifier to obtain service volume information of the roaming user; and

if the home location identifier of the user is the same as the identifier of the geographic area in which the single service volume is generated, determining that the user is a non-roaming user, and collecting, according to the data reporting parameter, statistics on single service volumes in all the user service volume information that includes the user identifier to obtain a service volume of the non-roaming user; and determining, according to service volumes of all non-roaming users, service volume information of one or more non-roaming users that meet the first condition.

Further, the data reporting parameter includes any one or a combination of the following: a service type, a time segment, and the first condition;

if the data reporting parameter includes the service type, the collecting, according to the data reporting parameter, statistics on service volumes of one or more roaming users and one or more non-roaming users to obtain user service data includes: collecting statistics on service volumes that are corresponding to the service type and that are of the roaming users and the non-roaming users to obtain the user service data; and

if the data reporting parameter includes the time segment, the collecting, according to the data reporting parameter, statistics on service volumes of one or more roaming users and one or more non-roaming users to obtain user service data includes: collecting statistics on service volumes that are corresponding to the time segment and that are of the roaming users and the non-roaming users to obtain the user service data.

Further, the first condition is a condition that a service volume is greater than a first preset threshold, or a condition that a service volume ranks before a first preset ranking in service volumes of all non-roaming users; and

the second condition is a condition that a total service volume is greater than a second preset threshold, or a condition that a total service volume ranks before a second preset ranking in total service volumes of all users.

Further, the obtaining a data reporting parameter associated with the data request message includes:

obtaining, according to a predetermined mapping relationship between the data request message and the data reporting parameter, the data reporting parameter associated with the data request message;

or, if the data request message carries a data reporting parameter, the obtaining a data reporting parameter associated with the data request message includes:

extracting the carried data reporting parameter from the data request message.

The sub online analytical processing server of this embodiment may be configured to implement the technical solution of the foregoing embodiment of the method for online data processing. The implementation principles and technical effects of the sub online analytical processing server are similar to those of the method embodiment, and details are not repeatedly described herein.

FIG. 9 is a schematic illustration of a system for online data processing according to embodiments of the present application. The system 90 includes a central OLAP server 901 and one or more sub OLAP servers 902-905 (the number of the OLAP servers is not limited herein).

It should be noted that in such system, the number of sub OLAP servers can be extended, the level of the OLAP servers can be extended, and the load of a single OLAP server can be extended or balanced between the servers.

Each sub OLAP server may further be provided, internally or externally, a disk array, where the disk array is configured to store various user information tables.

In an implementation manner, the central OLAP server 901 may be the central OLAP server shown in FIG. 5. Each sub OLAP server may have the structure of the sub OLAP server shown in FIG. 7.

In another implementation manner, the central OLAP server 901 is configured to send a data request message to the one or more sub OLAP servers; receive user service data sent from the one or more sub OLAP servers, where the user service data includes service volume information of one or more roaming users and service volume information of one or more non-roaming users that meet a first condition, and the service volume information of a user includes a user identifier and a service volume of the user; and sum up a total service volume for each user based on the service volume information of the user reported by the sub OLAP servers, and obtains total service volume information of each of selected users whose total service volumes meet a second condition. The total service volume information of a user includes a user identifier and a total service volume of the user; and

the sub OLAP server is configured to: receive a data request message sent from the central OLAP server 901, and obtain a data reporting parameter associated with the data request message; collect, according to the data reporting parameter, statistics on service volumes of one or more roaming users and one or more non-roaming users to obtain user service data; and send the user service data to the central OLAP server 901, where the user service data includes service volume information of the roaming users and service volume information of one or more non-roaming users that meet the first condition, and the service volume information of a user includes a user identifier and a service volume of the user.

Further, the central OLAP server 901 is specifically configured to:

send a data request message to the one or more sub OLAP servers; receive user service data sent by the one or more sub OLAP servers, where the user service data includes service volume information of one or more roaming users and service volume information of one or more non-roaming users that meet the first condition, and the service volume information of a user includes a user identifier and a service volume of the user;

sum up a total service volume for each user as a roaming user and a non-roaming user based on the user identifier of the user and the service volume of the user as reported by the sub OLAP servers; and

determine, based on the total service volume for each user, the total service volume information of each of the one or more users whose total service volume meets the second condition, where the total service volume information of a user includes a user identifier and a total service volume of the user.

Further, the sub OLAP server is specifically configured to:

receive a data request message sent by the central OLAP server 901;

obtain, according to a predetermined mapping relationship between the data request message and the data reporting parameter, the data reporting parameter associated with the data request message;

or, if the data request message carries a data reporting parameter, extract the carried data reporting parameter from the data request message;

receive at least one piece of user service volume information sent by a deep packet inspection device, where each piece of the user service volume information includes a user identifier of a user, a single service volume of the user, a home location identifier of the user, and an identifier of a geographic area in which the single service volume is generated;

if the home location identifier of the user is different from the identifier of the geographic area in which the single service volume is generated, determine that the user is a roaming user, and collect, according to the data reporting parameter, statistics on single service volumes in all the user service volume information that includes the user identifier to obtain service volume information of the roaming user, where the service volume information includes user identifiers and corresponding service volumes; or,

if the home location identifier of the user is the same as the identifier of the geographic area in which the single service volume is generated, determine that the user is a non-roaming user, and collect, according to the data reporting parameter, statistics on single service volumes in all the user service volume information that includes the user identifier to obtain a service volume of the non-roaming user; and determine, according to service volumes of all non-roaming users, service volume information of one or more non-roaming users that meet the first condition, where the service volume information includes user identifiers and corresponding service volumes; and

send the user service data to the central OLAP server 901, so that the central OLAP server 901 sums up a total service volume for each user based on the service volume information of the user reported by the sub OLAP servers, and obtains total service volume information of each of selected users whose total service volumes meet a second condition. The total service volume information of a user includes a user identifier and a total service volume of the user.

Further, the sub OLAP server is specifically configured to:

receive a data request message sent by the central OLAP server 901;

obtain, according to a predetermined mapping relationship between the data request message and the data reporting parameter, the data reporting parameter associated with the data request message;

or, if the data request message carries a data reporting parameter, extract the carried data reporting parameter from the data request message; where

the data reporting parameter includes any one or a combination of the following: a statistics-required service type parameter, a statistical time segment parameter, and the first condition;

if the data reporting parameter includes the statistics-required service type parameter, collect statistics on service volumes that are corresponding to the statistics-required service type parameter and that are of the roaming users and the non-roaming users to obtain user service data, where the user service data includes service volume information of the roaming users and service volume information of one or more non-roaming users that meet the first condition, and the service volume information of a user includes a user identifier and a service volume of the user; or,

if the data reporting parameter includes the statistical time segment parameter, collect statistics on service volumes that are corresponding to the statistical time segment parameter and that are of the roaming users and the non-roaming users to obtain user service data, where the user service data includes service volume information of the roaming users and service volume information of one or more non-roaming users that meet the first condition, and the service volume information of a user includes a user identifier and a service volume of the user; and

send the user service data to the central OLAP server 901, so that the central OLAP server 901 sums up a total service volume for each user based on the service volume information of the user reported by the sub OLAP servers, and obtains total service volume information of each of selected users whose total service volumes meet a second condition. The total service volume information of a user includes a user identifier and a total service volume of the user.

In the foregoing implementation manner, the central OLAP server 901 may be implemented by using the structure shown in FIG. 7, and each sub OLAP server may be implemented by using the structure shown in FIG. 8.

The system for online data processing of this embodiment may be configured to implement the technical solution of the foregoing embodiment of the online data processing method. The implementation principles and technical effects of the system are similar to those in the method embodiment, and details are not repeatedly described herein.

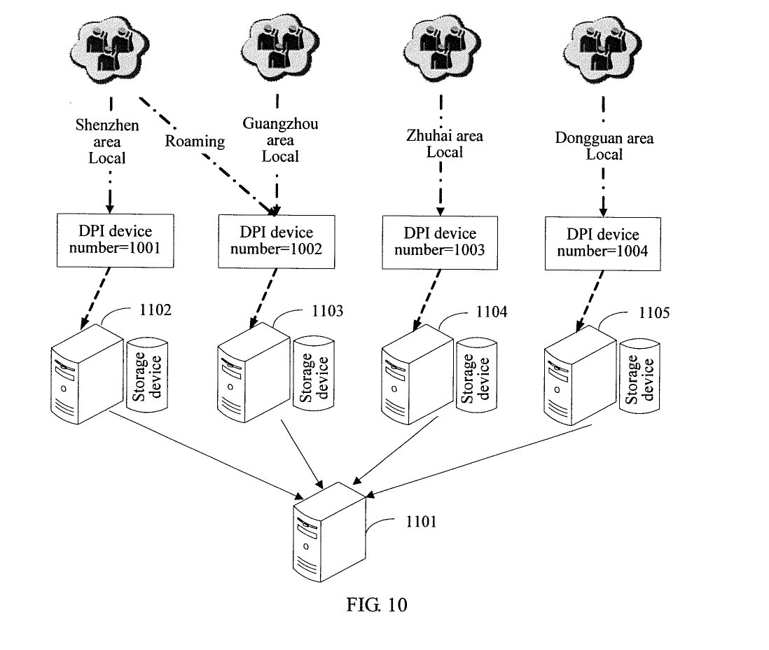

In a specific application process, as shown in FIG. 10, a sub OLAP server may further be connected to a DPI device. A first sub OLAP server 1102, a second sub OLAP server 1103, a third sub OLAP server 1104, and a fourth sub OLAP server 1105 are respectively connected to DPI devices numbered 1001, 1002, 1003, and 1004. When a DPI device learns that a user uses a service within a geographic area corresponding to the DPI device, the DPI device may send at least one piece of user service volume information to a sub OLAP server. Taking the DPI device numbered 1002 as an example, the DPI device 1002 sends user service volume information of a local user of Guangzhou area to the second sub OLAP server 1103, and also sends, to the second sub OLAP server 1103, user service volume information of a user who roams to Guangzhou area and whose home location is Shenzhen area.

Each sub OLAP server receives at least one piece of user service volume information sent by the DPI device. Particularly, each sub online OLAP server may further be provided internally with or be externally connected to a storage device, such as a disk array, where the disk array is configured to store various user information tables that include service volume information of users.

When each sub OLAP server receives a data request message sent from a central OLAP server 1101, each sub OLAP server obtains, according to the data request message and according to stored service volume information of users, service volume information of one or more roaming users and service volume information of one or more non-roaming users that meet a first condition.

Each sub OLAP server sends user service data to the central OLAP server 1101, including the service volume information of the roaming users and the service volume information of the one or more non-roaming users that meet the first condition.

The central OLAP server 1101 sums up a total service volume for each user based on the service volume information of the user reported by the sub OLAP servers, and obtains total service volume information of each of selected users whose total service volumes meet a second condition. The total service volume information of a user includes a user identifier and a total service volume of the user.

In summary, in the system for online data processing provided in this application, a central OLAP server sends a data request message to one or more sub OLAP servers, and the central OLAP server receives user service data sent by the one or more sub OLAP server. The user service data includes service volume information of one or more roaming users and service volume information of one or more non-roaming users that meet a first condition. In other words, the sub OLAP server screens non-roaming users, and the central OLAP server receives service volume information of only a part of non-roaming users. The central OLAP server sums up a total service volume for each user based on the service volume information of the user reported by the sub OLAP servers, and obtains total service volume information of each of selected users whose total service volumes meet a second condition, where the central OLAP server only needs to sum up service volumes that are of the roaming users and are reported by the sub OLAP server, and service volumes that are of the non-roaming users that meet the first condition and are reported by the sub OLAP server, that is, the sub OLAP server first collects statistics preliminarily, and then the central OLAP server further collects statistics based on a preliminary statistical result of the sub OLAP server, thereby reducing the amount of data processed by the central OLAP server, and improving the efficiency of data processing.

Persons of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present application rather than limiting the present application. Although the present application is described in detail with reference to the foregoing embodiments, persons of ordinary skill in the art should understand that they may still make modifications to the technical solutions described in the foregoing embodiments or make equivalent replacements to some or all technical features thereof, as long as such modifications or replacements do not cause the essence of corresponding technical solutions to depart from the scope of the technical solutions of the embodiments of the present application.

What is claimed is:

1. An online data processing method, comprising:
sending, by a central online analytical processing (OLAP) server, a data request message to one or more sub OLAP servers;
receiving, by the central OLAP server, user service data from the one or more sub OLAP servers, wherein the user service data comprises service volume information of one or more roaming users and service volume information of one or more non-roaming users that meet a first condition;
summing, by the central OLAP server, a total service volume for each user based on the service volume information of the user reported by the sub OLAP servers; and
obtaining total service volume information of each of selected users whose total service volumes meet a second condition, wherein the total service volume information of a user includes a user identifier and a total service volume of the user.

2. The method according to claim 1, wherein the first condition is a condition that a service volume is greater than a first preset threshold, or a condition that a service volume ranks before a first preset ranking in service volumes of all non-roaming users.

3. The method according to claim 1, wherein the second condition is a condition that a total service volume is greater than a second preset threshold, or a condition that a total service volume ranks before a second preset ranking in total service volumes of all users.

4. The method according to claim 1, wherein the data request message carries one or more data reporting parameters for collecting service volume information of each user according to the data reporting parameters.

5. The method according to claim 4, wherein the one or more data reporting parameters comprise any one or any combination of:
a service type;
a time segment; and
the first condition.

6. The method according to claim 1, wherein:
service volume information of a user as reported by each sub OLAP server comprises a user identifier and a service volume of the user; and
obtaining a subtotal service volume for each user based on the service volume information of the user reported by the sub OLAP servers comprises:
summing, by the central OLAP server, a total service volume for each user based on the user identifier of the user and the service volume of the user as reported by the sub OLAP servers.

7. The method according to claim 6, wherein a total service volume for each user is a sum of a service volume of the user as a roaming user and a service volume of the user as a non-roaming user.

8. An online data processing method, comprising:
receiving, by a sub online analytical processing (OLAP) server, a data request message from a central OLAP server;
obtaining, by the sub OLAP server, one or more data reporting parameters associated with the data request message;
collecting, according to the data reporting parameters, statistics on service volumes of one or more roaming users and one or more non-roaming users to obtain user service data, wherein the user service data comprises service volume information of the roaming users and service volume information of one or more non-roaming users that meet a first condition; and
sending, by the sub OLAP server, the user service data to the central OLAP server, so that the central OLAP server sums a total service volume for each user based on the service volume information of the user reported by the sub OLAP servers, and obtain total service volume information of each of selected users whose total service volumes meet a second condition, wherein the total service volume information of a user includes a user identifier and a total service volume of the user.

9. The method according to claim 8, wherein before collecting, according to the data reporting parameters, statistics on service volumes of one or more roaming users and one or more non-roaming users to obtain user service data, the method comprises:
receiving at least one piece of user service volume information sent by a deep packet inspection device, wherein each piece of the user service volume information comprises a user identifier of a user, a single service volume of the user, a home location identifier of the user, and an identifier of a geographic area in which the single service volume is generated.

10. The method according to claim 9, wherein collecting, according to the data reporting parameters, statistics on service volumes of one or more roaming users and one or more non-roaming users to obtain user service data comprises:
when the home location identifier of the user is different from the identifier of the geographic area in which the single service volume is generated, determining that the user is a roaming user, and collecting, according to the data reporting parameters, statistics on single service volumes in all the user service volume information that comprises the user identifier to obtain service volume information of the roaming user; and
when the home location identifier of the user is the same as the identifier of the geographic area in which the single service volume is generated, determining that the user is a non-roaming user, and collecting, according to the data reporting parameters, statistics on single service volumes in all the user service volume information that comprises the user identifier to obtain a service volume of the non-roaming user, and determining, according to service volumes of all non-roaming users, service volume information of the one or more non-roaming users that meet the first condition.

11. The method according to claim 8, wherein:
the data reporting parameters comprise any one or a combination of the following: a service type, a time segment, and the first condition;
when the data reporting parameters comprises the service type, collecting, according to the data reporting parameter, statistics on service volumes of one or more roaming users and one or more non-roaming users to obtain user service data comprises:
collecting statistics on service volumes that are corresponding to the service type and that are of the roaming users and the non-roaming users to obtain the user service data; and
when the data reporting parameters comprises the time segment, collecting, according to the data reporting parameter, statistics on service volumes of one or more roaming users and one or more non-roaming users to obtain user service data comprises:
collecting statistics on service volumes that are corresponding to the time segment and that are of the roaming users and the non-roaming users to obtain the user service data.

12. The method according to claim 8, wherein:
the first condition is a condition that a service volume is greater than a first preset threshold, or a condition that a service volume ranks before a first preset ranking in service volumes of all non-roaming users; or
the second condition is a condition that a total service volume is greater than a second preset threshold, or a condition that a total service volume ranks before a second preset ranking in total service volumes of all users.

13. A central online analytical processing (OLAP) server, comprising:
a memory;
a processor coupled with the memory;
a network interface configured to:
send a data request message to one or more sub OLAP servers, and
receive user service data from the one or more sub OLAP servers, wherein the user service data comprises service volume information of one or more roaming users and service volume information of one or more non-roaming users that meet a first condition; and
wherein the processor is configured to sum a total service volume for each user based on the service volume information of the user reported by the sub OLAP servers, and obtain total service volume information of each of selected users whose total service volumes meet a second condition, where the total service volume information of a user includes a user identifier and a total service volume of the user.

14. The central OLAP server according to claim 13, wherein:
the first condition is a condition that a service volume is greater than a first preset threshold, or a condition that a service volume ranks before a first preset ranking in service volumes of all non-roaming users; or
the second condition is a condition that a total service volume is greater than a second preset threshold, or a condition that a total service volume ranks before a second preset ranking in total service volumes of all users.

15. The central OLAP server according to claim 13, wherein:
service volume information of a user as reported by each sub OLAP server comprises a user identifier and a service volume of the user; and
the processor is further configured to sum a total service volume for each user based on the user identifier of the user and the service volume of the user as a roaming user and as a non-roaming user.

16. The central OLAP server according to claim 13, wherein the network interface is further configured to send a data request message that carries one or more data reporting parameters for collecting service volume information of each user according to the data reporting parameters, wherein the one or more data reporting parameters comprise any one or a combination of the following: a service type, a time segment, and the first condition.

17. A sub online analytical processing (OLAP) server, comprising:
a memory;
a network interface;
a network interface configured to receive a data request message sent from a central OLAP server;
a processor coupled with the memory and configured to:
obtain one or more data reporting parameters associated with the data request message,
collect, according to the data reporting parameters, statistics on service volumes of one or more roaming users and one or more non-roaming users to obtain user service data, wherein the user service data comprises service volume information of the roaming users and service volume information of one or more non-roaming users that meet a first condition; and
wherein the network interface is further configured to send the user service data to the central OLAP server, so that the central OLAP server sums a total service volume for each user based on the service volume information of the user reported by the sub OLAP servers, and obtains total service volume information of each of selected users whose total service volumes meet a second condition, wherein total service volume information of a user includes a user identifier and a total service volume of the user.

18. The sub OLAP server according to claim 17, wherein:
the network interface is further configured to:
receive at least one piece of user service volume information sent by a deep packet inspection device, wherein each piece of the user service volume information comprises a user identifier of a user, a single service volume of the user, a home location identifier of the user, and an identifier of a geographic area in which the single service volume is generated; and
the processor is further configured to:
when the home location identifier of the user is different from the identifier of the geographic area in which the single service volume is generated, determine that the user is a roaming user, and collect, according to the data reporting parameters, statistics on single service volumes in all the user service volume information that comprises the user identifier to obtain service volume information of the roaming user, and
when the home location identifier of the user is the same as the identifier of the geographic area in which the single service volume is generated, determine that the user is a non-roaming user, and collect, according to the data reporting parameters, statistics on single service volumes in all the user service volume information that comprises the user identifier to obtain a service volume of the non-roaming user; and determine, according to service volumes of all non-roaming users, service volume information of the one or more non-roaming users that meet the first condition.

19. The sub OLAP server according to claim 17, wherein:
the data reporting parameters comprises any one or a combination of the following: a service type, a time segment, and the first condition; and
the processor is further configured to:
collect statistics on service volumes that are corresponding to the service type and that are of the roaming users and the non-roaming users to obtain user service data when the data reporting parameters comprises the service type, wherein the user service data comprises service volume information of the roaming users and service volume information of one or more non-roaming users that meet the first condition, or
collect statistics on service volumes that are corresponding to the time segment and that are of the roaming users and the non-roaming users to obtain user service data when the data reporting parameters comprises the time segment, wherein the user service data comprises service volume information of the roaming users and service volume information of one or more non-roaming users that meet the first condition.

20. A system for online data processing, the system comprising:
a central online analytical processing (OLAP) server and one or more sub OLAP server;
wherein the central OLAP server is configured to:
send a data request message to the one or more sub OLAP server,
receive user service data from the one or more sub OLAP servers, wherein the user service data comprises service volume information of one or more roaming users and service volume information of one or more non-roaming users that meet a first condition,
sum a total service volume for each user based on the service volume information of the user reported by the sub OLAP servers, and
obtain total service volume information of each of selected users whose total service volumes meet a second condition, wherein total service volume information of a user includes a user identifier and a total service volume of the user; and
wherein the sub OLAP server is configured to:
receive a data request message from the central OLAP server, and obtain one or more data reporting parameters associated with the data request message,
collect, according to the data reporting parameters, statistics on service volumes of one or more roaming users and one or more non-roaming users to obtain user service data, and
send the user service data to the central OLAP server, wherein the user service data comprises service volume information of one or more roaming users and service volume information of one or more non-roaming users that meet the first condition.
